(19) United States
(12) Patent Application Publication
(10) Pub. No.: US 2005/0159536 A1
(43) Pub. Date: Jul. 21, 2005

(54) Stable polymer compositions and methods of making same

(76) Inventor: Marvin McClinton Smith, Philadelphia, PA (US)

Correspondence Address: REED SMITH LLP, 2500 ONE LIBERTY PLACE, 1650 MARKET STREET, PHILADELPHIA, PA, 19103, US

(21) Appl. No.: 10/758,963

(22) Filed: Jan. 16, 2004

(51) Int. Cl. C08J 3/02

(52) U.S. Cl. 524/501

(57) ABSTRACT

The present invention comprises a polymer composition which is comprised of subcompositions which are separately stable within the polymer composition and methods of making the polymer compositions. These polymer compositions may be useful as coatings for paper, food packaging, vinyl, plastics, man-made substrates, wood and metal. An advantage of these polymer composition is that they are aqueous non-fluorocarbon polymers, which are less pollutive than state of the art polymer coatings.

### I. BACKGROUND OF THE INVENTION

This invention relates to stable polymer compositions. Polymer chemistry is an unpredictable field and often yields unstable compositions, which are difficult to use because the composition changes over time.

Polymer compositions are used in many fields for many uses including coatings.

In the coatings industry, most coatings comprise fluorocarbon and/or polyolefin polymers which are undesirable for many reasons such as environmental pollution concerns, difficulty in producing the coatings, high costs, and safety concerns in manufacturing. The present invention does not include fluorocarbon or polyolefin polymers and may be used as coatings which are stable, relatively inexpensive and easily formed without the environmental concerns associated with fluorocarbons. The present invention comprises aqueous non-fluorocarbon polymer emulsions, which may be used in coatings.

### II. SUMMARY OF THE INVENTION

According to the present invention, polymer compositions which are very stable may be formed and used as coatings for a variety of substrates, including but not limited to paper (including but not limited to food packaging), vinyl, plastics, other man-made substances, metal, and wood. Some of the coatings may be heat resistant, grease resistant and/or acceptable for food packaging.

Without being limited to this mechanism, it is believed that the following is the mechanism of action for the stable polymer compositions. Entropy is the disorder of a system, and in thermodynamics, entropy approaches zero for a system when the process is reversible (this is referred to as the Second Law of Thermodynamics). See Perry's Chemical Engineers' Handbook, Sixth Edition (1984) p. 4-53 (herein incorporated by reference). Conversely, systems which are very stable have high entropies. In the present invention, it is believed without limitation, that the polymer composition (or composition) may have subcompositions, which may be correlated to the phases as set forth in the examples below. It is believed without limitation that the subcompositions have high entropy and when the subcompositions are placed in the composition, the composition has high entropy and therefore is very stable. The high entropy of the composition also means that the composition is more likely to be irreversible and increases the stability of the composition. This high entropy may also increase the overall glass transition temperature and thermal stability and decrease thermal decomposition of the composition.

Further, without limitation, it is believed that the existence of subcompositions within the composition reduces the amount of energy required to increase the entropy. Without being limited, it is believed that the stability of the composition results in an increased shelf life, and the high level of entropy decreases the amount of heat energy needed to change the state of the polymer composition.

The present invention comprises a composition which is made up of one or more subcompositions. The compositions may be emulsions, dispersions, suspensions, and solutions, preferably emulsions, until dried. The subcompositions are formed, are stable and do not react further even when present in the composition, which may include other subcompositions (which may or may not have the same components). Some embodiments of the subcompositions have been sufficiently stable to pass sheer tests, which means that they have good sheer strength.

The compositions may be dried according to drying methods known to one of ordinary skill in the art, preferably by exposure to air at about atmospheric pressure and about room temperature. It is believed, without limitation, that in some preferred embodiments, each subcomposition forms a separate layer after the polymer composition is applied as a coating and dries.

### III. DETAILED DESCRIPTION OF THE INVENTION

The compositions are made by forming separate subcompositions, preferably in sequence. In this specification, a “phase” forms a separate subcomposition. In certain embodiments, if the subcompositions are not formed in sequence, but rather all of the materials are combined at the same time, the composition may form a gel instead of an emulsion. The emulsion is preferred. Each composition preferably has a pH of between about 8 and about 9.5, and the viscosity of the composition is preferably about 300 cps to about 1500 cps measured on a Brookfield Viscometer LVF with spindle #12.

When each subcomposition is formed, in preferred embodiments, some of the components of certain subcompositions may be added repeatedly, so that the total amount of a component needed in the subcomposition is divided and added at different times or added repeatedly alternating with some or all of the remaining components in that subcomposition.

Specific, non-limiting examples of subcompositions that may (without limitation) be formed by repeated addition of the required components in portions (with the repeated portion amounts equaling the total amount of component in the subcomposition) to a given subcomposition are as follows:
Example A: a subcomposition including without limitation one or more ethylene-vinyl chloride emulsions and one or more acrylic emulsions;
Example B: a subcomposition including without limitation one or more acrylic resin, one or more acrylic emulsions and one or more ethylene-vinyl chloride emulsions;
Example C: a subcomposition including without limitation one or more ethylene-vinyl chloride emulsions;
Example D: a subcomposition including without limitation one or more acrylic emulsions and one or more vinyl acetate emulsions;
Example E: a subcomposition including without limitation one or more acrylic resins, one or more acrylic emulsions and one or more vinyl acetate emulsions;
Example F: a subcomposition including without limitation one or more acrylic resins and one or more acrylic emulsions;
Example G: a subcomposition including without limitation one or more acrylic resins, one or more acrylic emulsions and water;
Example H: a subcomposition including without limitation one or more acrylic emulsions
Example I: a subcomposition including without limitation one or more acrylic emulsions, and one or more waxes
Example J: a subcomposition including without limitation one or more acrylic emulsions, water, one or more acrylic colloid dispersions, and propylene glycol.

If a given component is added in portions to the subcomposition instead of the total amount at once, the number of repetitions a given component added in portions may be as low as two times and as high as desired for the particular coating and its use, preferably 2 to 9 times, more preferably 3 to 8.

Each subcomposition within the composition (also called the polymer composition) may comprise the identical components as other subcompositions or may comprise one or more different components from other subcompositions. Each subcomposition may exist more than once in a composition as a separate stable entity.

In preferred embodiments, each subcomposition is formed at about room temperature and about atmospheric pressure under constant mixing. Preferably, all of one subcomposition's components are added under constant mixing before any other subcomposition's components are added to the composition.

In a preferred embodiment, each composition comprises at least two different subcompositions.

In preferred embodiments, the subcompositions are formed in sequence with continuous mixing and at about room temperature and about atmospheric pressure. Room temperature in this specification is about 75° F. Each subcomposition may separately be formed and exist without the other subcompositions, as its own polymer composition.

In some preferred embodiments, pastes, such as without limitation, compositions including clays, starches, pastes, metal oxides and combinations thereof may be desirable to improve a polymer composition's coating characteristics. Preferably, these pastes may be added to a premix (or other subcomposition) preferably under constant mixing and about room temperature and about atmospheric pressure.

In a preferred embodiment, a paste comprises at least one metal oxide(e.g. without limitation Hydrogloss 90 from J. M. Huber), baking soda, starch (e.g. without limitation Catosize 270A from National Starch), water, and one or more acrylic resins (e.g. without limitation Joncryl® HPD 96). Another preferred embodiment of a paste comprises at least one metal oxide (e.g. without limitation Hydrogloss 90 from J. M. Huber), baking soda, starch (e.g. without limitation Catosize 270A from National Starch), water, and one or more acrylic colloid (e.g. without limitation Vancryl® 450). Another preferred embodiment of a paste comprises at least one metal oxide (e.g. without limitation Hydrogloss 90 from J. M. Huber), baking soda, starch (e.g. without limitation Catosize 270A from National Starch), water, one or more acrylic resins (e.g. without limitation Joncryl® HPD 96) and one or more acrylic colloid (e.g. without limitation Vancryl® 450).

In this specification, all components with the trademarks Joncryl or Jonwax are sold by Johnson Polymer, LLC. All components with the trademark Vancryl are sold by UCB Chemical Group.

Acrylic Resins include, but are not limited to copolymers with other acrylic monomers, copolymers with other acrylic polymers, styrenated acrylic resins, styrenated acrylic resin solutions, Acrylic Emulsions made from Acrylic Resins and/or Acrylic Resin Solutions, Joncryl® HPD 96, Joncryl® 56, Joncryl® 57, Joncryl® 58, Joncryl® 59, Joncryl® 60, Joncryl® 61, Joncryl® 62, Joncryl® 63, Joncryl® 70, Joncryl® HPD 71, Joncryl® 73, Joncryl® ECO 75, Joncryl® ECO 84, Joncryl® DFC 3015, Joncryl® DFC 3025, Joncryl® 52, Joncryl® 50, Vancryl® 65, Vancryl® 68, Vancryl® 68S, Vancryl® 710, Joncryl® 67, Joncryl® 586, Joncryl® 611, Joncryl® HPD 671, Joncryl® ECO 675, Joncryl® 678, Joncryl® 680, Joncryl® 682, Joncryl® ECO 684, Joncryl® 690, Joncryl® 693, Joncryl® HPD 696 and combinations thereof.

Acrylic Emulsions include, but are not limited to emulsions made from the following: copolymers with other acrylic monomers, copolymers with other acrylic polymers, acrylic binders, acrylic vinyl acetate co-polymers, acrylic vinyl ethylene co-polymers, acrylic vinyl ethylene chlorides co-polymer blends, acrylics co-polymer of any wax, acrylic paraffin wax copolymer, acrylic paraffin blends, acrylic polyethylene wax co-polymer blends, acrylic co-polymer blends with polypropylene waxes, acrylic co-polymers and co-polymer blends with glycols and polyhydric alcohols, acrylic copolymer and copolymer blends of polycarbonates, acrylic copolymers and co-polymers of polyurethanes, acrylic copolymers and copolymer blends of phthalates, styrenated acrylic emulsions, Joncryl® 74, Joncryl® 77, Joncryl® 585, Joncryl® 617, Joncryl® 624, Joncryl® 660, Joncryl® 1536, Joncryl® HRC 1645, Joncryl® HRC 1620, Joncryl® HRC 1661, Joncryl® HRC 1663, Joncryl® 1695, Joncryl® ECO 2117, Joncryl® ECO 2124, Joncryl® ECO 2177, Joncryl® 2178, Joncryl® 2640, Joncryl® 2641, Joncryl® 2660, Joncryl® DFC 3030, Joncryl® DFC 3040, Joncryl® DFC 3060, Vancryl® 989, Vancryl® 937, Vancryl® 965, Vancryl® 960, Vancryl® 965, Vancryl® 960, Vancryl® 965 DEV, Vancryl® 990 EXP, Joncryl® 89, Joncryl® 537, Joncryl® 538, Joncryl® 631, Joncryl® 1680, Joncryl® 2153, Joncryl® 2161, Joncryl® ECO 2189, Joncryl® DFC 3050, and combinations thereof.

Waxes include, but are not limited to Jonwax® 4, Jonwax® 22, Jonwax® 26, Jonwax® 28, Jonwax® 39, Jonwax® 120, Vancryl® 35, and combinations thereof.

Ethylene-Vinyl Chloride Emulsions include, but are not limited to Vancryl® 600, Vancryl® 605, and Vancryl® 610, and combinations thereof. 124] Vinyl Acetate Emulsions include, but are not limited to Vancryl® 825 and Vancryl® 650, and combinations thereof.

Acrylic Colloid Dispersions include, but are not limited to Vancryl® 445, Vancryl® 450, Vancryl® 454, Joncryl® 91, Joncryl® 99, Joncryl® 100, Joncryl® 142, Joncryl® 637, Joncryl® 638, Joncryl® 646, Joncryl® 647, Joncryl® 655, and combinations thereof.

Starches include, but are not limited to amylose molecules, amylopectin, corn, wheat, potato, tapioca, rice, rye, chemical configurations of alpha-D-glucose units in the 4C1 conformation (in amylose these are linked 1-4 or 1-6), cationic starches, anion starches, nonionic starches, hydroxy-ethyl-starch, wet end starches, modified starches, surface treatment starches, cooking starches, low-gel temperature starch, Anilox 375 by Kistan Starch Company, Ethanil 50 by Kistan Starch Company, Paprilose by Kistan Starch Company, Anilox 40 by Kistan Starch Company, Ethanil 90 by Kistan Starch Company, Spraynil by Kistan Starch Company, Sprayanil-Glo by Kistan Starch Company, catoril by Kistan Starch Company, aniloteric 210 by Kistan Starch Company, RX2000 by Rantec, starch derivatives, acetylated distarch adipate, acetylates distarch phosphate, acteylated starch, acid-thinned starch, agglomerated starch, allyl starch, alpha amylase, amphoteric starch, amylopectin, anhydroglucose units, anionic starch, AOX-free starch products (absorbable organic halides starches), arrowroot starch, beta amylase, bleached starch, british gum starches, carboxymethyl starch, cassava starch, cationic starch, cereal starch, chemical gelatinization starch, chemically modified starch, chlorhydrins, chlorinated starch, chlorine-free starches, coating starch, cold water soluble starch, corrugating starch, cross-linked starch, chemical modified crosslinked starches, crystal starch, cyclodextrin, acetylated distarch adipate, acetylated distarch phosphate, acetylated starch, acid-thinned starch, agglomerated starch, allyl starch, alpha amylase, amphoteric starch, amylopectin, anhydroglucose units, anionic starch, AOX-free starch products (absorbable organic halides starches), arrowroot starch, beta amylase, bleached starch, british gum starches, carboxylmethyl starch, cassava starch, cationic starch, cereal starch, chemical gelatinization starch, chemically-modified starch, chlorhydrins, chlorinated starch, chlorine-free starches, coating starch, cold water soluble starch, corrugating starch, crosslinked starch, chemical modified crosslinked starches, crystal starch, cyclodextrin, dextrin, dextrose-d-glucose, dextrose monohydrate, dialdehyde starch, distarch glycerol, distarch phosphate, drum-dried starch, dual modified starch, dusting starch, emulsifying starch, extruded starch, farina potato starch, food starch, gentobiose 1,6-b-glucosidoglucose, granular pre-swollen starch, granules-starch, granules size-starch, heat and moisture treated starch, high amylose starch, hydrophobic starch (for example without limitation ester starch n-octenyl succinate-made from treating starch with n-octenyl succinate anhydride) paper sizing starch, hydroxylpropyl starch, inhibited starch—crosslinked starch produced by treatment with a bi- or polyfunctional reagent, laundry starch, lintner starch, low viscosity starches, lump starches, maize starch, maltodextrin starch, malto-oligosaccharide, modified starch, molar substitution starches, monostarch phosphate, moulding starch, native starch, no carrier-starch-corn starch, oligosaccharides, oxidized starch (starches modified with sodium hypochlorite), pearl starch, physically modified starch, plastified starch (thermoplastic starch), potato-pulp starch, powdered starch, pregelatinized starches, resistant starch, rice starch, rye starch, saccharification hydrolyzed starch, sago starch, semi-dry modification starch, solubilized starch, sorghum starch, special starch, spray starch, starch, starch acetate, starch adipate, starch alkenyl succinate, starch derivatives, starch ester, starch ether, starch film, starch gel, starch hydrolysate, starch hydrolysis products, starch laurate, starch nitrate, starch octenyl succinate, starch paste, starch phosphate, starch slurry, starch succinate, starch xanthate, sterilizable starch, super dry starch, starch slurper (named for starch/acrylonitrile graft copolymer), surface treatment starch, sweet potato starch (bleached sweet potatoes starch), tabletting starch, tapioca starch, thermo-chemical conversion starch, thermo-plastic starch, thick-boiling starch, thin boiling starch, amylose molecules and combinations thereof.

Methylcelluloses include, but are not limited to methylcellulose, hydroxypropyl methylcellulose, ethyl cellulose, hydroxyethyl cellulose, 2-hydroxypropyl ether of methyl cellulose, propylene glycol ether of methylcellulose, 2-hydroxypropyl methyl ether, modified cellulose, hypromellose, methyl hydroxy propyl cellulose (“MHPC”), carbohydrate gum, low viscosity hydroxypropyl methylcellulose, medium viscosity hydroxypropyl methylcellulose, high viscosity hydroxypropyl methylcellulose, ultra high viscosity hydroxypropyl methylcellulose (e.g. Bencel® MP643, Isopto-Tears, Methopt, PolyTears, Tears Naturale, Methocel A, Methocel, Methocel F, Methocel J, Methocel K, Methocel 310 Series, Methocel A 15LV, Methopt, Pharmacoat®/Metrolose, Low Viscosity Methocel, Medium Viscosity Methocel, High Viscosity Methocel, low viscosity methylcellulose, medium viscosity methylcellulose, high viscosity methylcellulose, ethylcellulose, hydroxyethyl cellulose, cellulose derivatives, Ethocel, Ethoxyl Cellulose, Low Viscosity Ethylcellulose, Medium Viscosity Ethylcellulose, High Viscosity Ethylcellulose, and Ultra High Viscosity Ethylcellulose, Cellosize hydroxyethyl cellulose, Cellosize HEC, low viscosity Hydroxyethyl cellulose (WP/QP 09L, WP/QP 09H, EP 09, QP 3L), medium viscosity hydroxyethyl cellulose (QP 40, WP/QP 300, EP 300, ER 4400, QP 4400H, QP 10000H), high viscosity hydroxyethyl cellulose (QP 15000H, QP 30000H, WP/QP 52000H and QP100MH, ER 15000, ER 30000, ER 52000), Ultra High Viscosity Hydroxyethyl cellulose, POLYOX Water-Soluble Resins WRS-30, WSR 303, WSR Coagulant, WSR-301, WSR N-10, WSR N-750, WSR N-80, WSR-205, WSR N-60K, WSR-301NF, WSR N-3000, WSR N-12K, WSR N-60, WSR-205 NF, WSR N 80, WSR-1 105, WSR-308, UCARFLOC 302, UCARFLOC 304, UCARFLOC 309, UCARFLOC 300, and combinations thereof. WSR and UCARFLOC products are provided by Dow Chemical Company.

Bicarbonates include, but are not limited to sodium bicarbonates, baking soda, sodium hydrogen carbonate, ammonium hydrogen carbonate, ammonium bicarbonate, potassium bicarbonate, potassium hydrogen carbonates, and calcium bicarbonate, and combinations thereof.

Hydroxides include, but are not limited to ammonium hydroxide, calcium hydroxide, magnesium hydroxide, potassium hydroxide, and sodium hydroxide, and combinations thereof.

Combinations of Bicarbonates and Hydroxides may be used in the invention.

Polymers comprise repeated units in a chain and include, but are not limited to monomer produced polymers (including but not limited to synthetic polymers and natural polymers and combinations of synthetic and natural polymers in blended or copolymer combinations), cationic polymers, anionic polymers, nonionic polymers, polymers described as liquid crystals, water based polymers, solvent based polymers, combinations of water based and solvent based polymers, acid based polymers, alkaline based polymers, organic polymers, inorganic polymers, natural polymers, synthetic polymers, blended polymers, crosslinked polymers, nonlinear polymers, conducting polymers, non-conducting polymers, copolymers, conjugated polymers, homo-polymers, homeopolymers, heteropolymers, metapolymers, pseudopolymers, cis-polymers, trans-polymers, dipolymers, tri-polymers, tetra-polymers, copolymer blends, homo-polymer blends, polymer systems (P-Systems), polymer emulsions, polymer resins, waxes, laevo-polymers or 1-polymers, dextro-polymers or D-polymers, lineomers—straight line, straight chain polymers, cyclomers—cyclic polymers, cyclo-polymers, circle polymers, aromatic polymers, polymer-astromer, annulomer, crystomers, addition polymers, condensation polymers, plastics, rubbers, epoxy resin polymers, gel polymers, thermoset polymers, thermoplastics, elastic polymer, amorphous polymers, poly-tetra-fluoroethylene (PTFE), polyacrylamides, polyisocynates, polycarbonates, poly vinyl acetates, poly vinyl chlorides, poly styrenate acrylics, poly-isoprenes, poly-isobutylenes, poly-chloroprenes, poly-dicyclopentadienes, poly (methylacrylates), poly (p-phenylene vinylenes), poly-anilines, poly-nitriles, poly-butadienes, latex, dicarboxylic acids, diamines, amines, glycols, diglycols, glycol ethers, diglycol ethers, polyhydric alcohols, alcohols, polyethylenes, polypropylenes, polyethers, polyesters, polyimides, polyamides, nylons, polyurethanes, polystyrenes, styrene acrylics, polyethylene vinyl chlorides, polyethylene vinyl acetates, polyethylene terephthalates, polyethylene terephthalatic esters, acrylics, acrylic resins, phthalates, aromatic structured polymers, and linear structured polymers.

Clays include, but are not limited to metal oxides, derivatives of clays and metal oxides, hydrated aluminum silicate, kaolin, kaolin clay, china clay, hydrafine 90, Hydrogloss 90 (Hydroglosses provide by J. M. Huber), HydroGloss 92, CoverGloss, Zirconium Oxides, Aluminum Oxides, Calcium Oxides, Iron Oxides, Magnesium Oxides, Sodium Oxides, Silica Oxides, titanium oxides, cerium oxides, dysprosium oxides, erbium oxides, europium oxides, gadolinium oxides, holium oxides, lanthanum oxides, lutetium oxides, neodymium oxides, praseodymium oxides, samarium oxides, scandium oxides, terbium oxides, thulium oxides, yttrium oxides, gallium oxides, germanium oxides, hafnium oxides, indium oxides, niobium oxides, tantalum oxides, vanadium oxides, bismuth silicone oxides, bismuth germanium oxides, bismuth titanyl oxides, lead molybdate crystals, lithium iodate crystals and/or oxides, lithium niobate crystals and/or oxides, sodium-bismuth molibdate crystals and/or oxides, tellurium dioxide acousto-optical crystals, optical crystals, quartz crystals, calcite crystals, rutile crystals, polarization crystals, laser crystals, NLO crystals, halogenides, any metallic oxide, any metallic crystal, and combinations thereof

Acrylics include, but are not limited to Acrylic Colloids, Acrylic Colloid Dispersions, Colloids, Acrylic Resins, Acrylic Resin Solutions, Acrylic Emulsions, Acrylic Film-Formers, Acrylic Non-film Formers, Acrylic Blends (including but not limited to co-polymer blends and homopolymer blends), Acrylic Vinyl Acetates, Acrylic Vinyl Ethylenes, Acrylic Vinyl Chlorides; co-polymers with vinyl acetates, vinyl ethylene acetate, vinyl ethylene chlorides, butadienes and other natural or synthetic rubbers; copolymers with neoprenes, other acrylics and other co-polymers; homopolymers; homopolymer binders; Kemicryl 3258P, Kemicryl 8820P, Kemicryl 435T, Kemicryl—ECC, Kemicryl SL, Kemicryl EC, Kemicryl GB30, Kemicryl F2, Kemicryl S804, Vancryl® 989, Vancryl® 937, RhoPlex, RhoPlex Acrylics Binders by Rohm and Haas, Styrene Acrylic Binders, Vinyl Acrylic Copolymer Binders, Vinyl Acetate Homopolymer Binders, Vinyl Acetates and/or its copolymers, Vinyl Acetate Emulsions and/or its copolymers, Vinyl Ethylene-Chloride Emulsions and/or its copolymers, Vinyl Ethylene Chlorides and/or its copolymers, Ethylene Vinyl-chlorides, and Ethylene vinyl-chloride emulsions, and combinations thereof.

Premixes may be prepared and then the polymer compositions may be prepared by adding the components to the premix. These premixes may include but are not limited to encapsulated clays and/or encapsulated pastes. Preferred components of the premix include but are not limited to clays, pastes, Joncryl® 660, Vancryl® 989, Joncryl® 2641, Joncryl® 120, Joncryl® 74, Joncryl® 1674, and combinations thereof.

Water includes, but is not limited to, distilled water and tap water. The preferred tap water is tap water in Philadelphia, Pa.

### EXAMPLE 1

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Joncryl ® 660 | 250 |
| Vancryl ® 989 | 160 |
| Vancryl ® 937 | 70 |
| Phase 2 | |
| Vancryl ® 605 | 35 |
| Vancryl ® 989 | 35 |
| Phase 3 | |
| Vancryl ® 605 | 35 |
| Vancryl ® 989 | 35 |
| Phase 4 | |
| Vancryl ® 605 | 35 |
| Vancryl ® 989 | 35 |
| Phase 5 | |
| Vancryl ® 937 | 35 |
| Vancryl ® 610 | 35 |
| Phase 6 | |
| Vancryl ® 937 | 35 |
| Vancryl ® 610 | 35 |
| Phase 7 | |
| Vancryl ® 937 | 35 |
| Vancryl ® 610 | 35 |
| Phase 8 | |
| Joncryl ® 74 | 55 |
| Vancryl ® 965 | 54 |
| Joncryl ® 74 | 55 |
| Phase 9 | |
| Vancryl ® 989 | 35 |
| Vancryl ® 605 | 35 |
| Phase 10 | |
| Vancryl ® 989 | 35 |
| Vancryl ® 605 | 35 |
| Phase 11 | |
| Vancryl ® 989 | 35 |
| Vancryl ® 605 | 35 |
| Phase 12 | |
| Vancryl ® 610 | 35 |
| Vancryl ® 937 | 35 |
| Phase 13 | |
| Vancryl ® 610 | 35 |
| Vancryl ® 937 | 35 |
| Phase 14 | |
| Vancryl ® 610 | 35 |
| Vancryl ® 937 | 35 |
| Phase 15 | |
| Vancryl ® 989 | 35 |
| Vancryl ® 937 | 35 |
| Joncryl ® 660 and | 92 |
| Water combined first | 32 |
| Vancryl ® 937 | 35 |
| Joncryl ® 537 | 60 |
| Joncryl ® 120 and | 80 |
| Joncryl ® 1674 combined first | 80 |

### EXAMPLE 2

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Joncryl ® 660 | 250 |
| Vancryl ® 989 | 160 |
| Vancryl ® 937 | 70 |
| Phase 2 | |
| Joncryl ® 77 | 38 |
| Vancryl ® 610 | 35 |
| Phase 3 | |
| Joncryl ® 77 | 38 |
| Vancryl ® 610 | 35 |
| Phase 4 | |
| Joncryl ® 77 | 38 |
| Vancryl ® 610 | 35 |
| Phase 5 | |
| Vancryl ® 937 | 35 |
| Vancryl ® 610 | 35 |
| Phase 6 | |
| Vancryl ® 937 | 35 |
| Vancryl ® 610 | 35 |
| Phase 7 | |
| Vancryl ® 937 | 35 |
| Vancryl ® 610 | 35 |
| Phase 8 | |
| Joncryl ® 74 | 55 |
| Vancryl ® 965 | 54 |
| Joncryl ® 74 | 55 |
| Phase 9 | |
| Vancryl ® 610 | 35 |
| Joncryl ® 77 | 38 |
| Phase 10 | |
| Vancryl ® 610 | 35 |
| Joncryl ® 77 | 38 |
| Phase 11 | |
| Vancryl ® 610 | 35 |
| Joncryl ® 77 | 38 |
| Phase 12 | |
| Vancryl ® 610 | 35 |
| Vancryl ® 937 | 35 |
| Phase 13 | |
| Vancryl ® 610 | 35 |
| Vancryl ® 937 | 35 |
| Phase 14 | |
| Vancryl ® 610 | 35 |
| Vancryl ® 937 | 35 |
| Phase 15 | |
| Vancryl ® 989 | 35 |
| Vancryl ® 937 | 35 |
| Joncryl ® 660 | 92 |
| WATER | 32 |
| Vancryl ® 937 | 35 |
| Joncryl ® 537 | 60 |
| Joncryl ® 120 | 80 |
| Joncryl ® 1674 | 80 |

It is also possible to prepare this Example 2 after preparing one of the following premixes and then adding Example 2 to one of the premixes. The premixes are prepared preferably at about room temperature and about atmospheric pressure under constant mixing.

The premixes may be made with any one of three pastes (“Pastes”) below. The Pastes are prepared preferably at about room temperature and about atmospheric pressure under constant mixing. It is preferable to add the components in order.

| | Weight percent |
|---|---|
| Component | of total Paste |
| Paste 1 | |
| Hydrogloss 90 | 16.66 |
| Baking Soda | 16.66 |
| Catosize 270A (provided by | 16.66 |
| National Starch) | |
| water | 33.33 |
| Vancryl 450 | 16.66 |
| Paste 2 | |
| Hydrogloss 90 | 17.7 |
| Baking Soda | 17.7 |
| Catosize 270A (provided by | 17.7 |
| National Starch) | |
| water | 20 |
| Joncryl HPD 96 | 26.66 |
| Paste 3 | |
| Hydrogloss 90 | 12.5 |
| Baking Soda | 12.5 |
| Catosize 270A (provided by | 12.5 |
| National Starch) | |
| water | 25 |
| Vancryl 450 | 12.5 |
| Joncryl HPD 96 | 25 |

| Component | Weight (in grams) |
|---|---|
| Pre-Mix 1 | |
| Joncryl ® 660 | 500 |
| Vancryl ® 989 | 500 |
| Paste | 1000 |
| Joncryl ® 77 | 500 |
| Vancryl ® 989 | 500 |
| Paste | 1000 |
| Pre-Mix 2 | |
| Vancryl ® 937 | 500 |
| Water | 500 |
| Acrylic Colloids | 400 |
| Paste | 1000 |
| Joncryl ® 77 | 500 |
| Vancryl ® 989 | 500 |
| Paste | 1000 |
| Pre-Mix 3 | |
| Joncryl ® 77 | 500 |
| Vancryl ® 989 | 500 |
| Clays or Pastes | 1000 |
| Joncryl ® 77 | 500 |
| Vancryl ® 989 | 500 |
| Paste | 1000 |
| Pre-Mix 4 | |
| Vancryl ® 937 | 500 |
| Vancryl ® 989 | 500 |
| Paste | 1000 |
| Joncryl ® 77 | 500 |
| Vancryl ® 989 | 500 |
| Paste | 1000 |
| Pre-Mix 5 | |
| Joncryl ® 660 | 500 |
| Paste | 500 |
| Vancryl ® 989 | 500 |
| Paste | 500 |
| Joncryl ® 77 | 500 |

### EXAMPLE 3

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Joncryl ® 660 | 250 |
| Vancryl ® 989 | 160 |
| Vancryl ® 937 | 70 |
| Phase 2 | |
| Joncryl ® HPD 96 | 55 |
| Joncryl ® 77 | 38 |
| Vancryl ® 989 | 38 |
| Vancryl ® 605 | 38 |
| Phase 3 | |
| Joncryl ® HPD 96 | 55 |
| Joncryl ® 77 | 38 |
| Vancryl ® 989 | 38 |
| Vancryl ® 605 | 38 |
| Phase 4 | |
| Joncryl ® HPD 96 | 55 |
| Joncryl ® 77 | 38 |
| Vancryl ® 989 | 38 |
| Vancryl ® 605 | 38 |
| Phase 5 | |
| Joncryl ® HPD 96 | 55 |
| Joncryl ® 77 | 38 |
| Vancryl ® 989 | 38 |
| Vancryl ® 605 | 38 |
| Phase 6 | |
| Joncryl ® HPD 96 | 55 |
| Joncryl ® 77 | 38 |
| Vancryl ® 989 | 38 |
| Vancryl ® 605 | 38 |
| Phase 7 | |
| Joncryl ® HPD 96 | 55 |
| Joncryl ® 77 | 38 |
| Vancryl ® 989 | 38 |
| Vancryl ® 605 | 38 |
| Phase 8 | |
| Joncryl ® HPD 96 | 55 |
| Joncryl ® 77 | 38 |
| Vancryl ® 989 | 38 |
| Vancryl ® 605 | 38 |
| Phase 9 | |
| Joncryl ® HPD 96 | 55 |
| Joncryl ® 77 | 38 |
| Vancryl ® 989 | 38 |
| Vancryl ® 605 | 38 |
| Phase 10 | |
| Joncryl ® HPD 96 | 50 |
| Vancryl ® 937 | 50 |
| Vancryl ® 989 | 50 |
| Joncryl ® 2641 | 50 |
| Vancryl ® 965 | 50 |
| Joncryl ® 2641 | 50 |
| Vancryl ® 989 | 50 |
| Vancryl ® 937 | 50 |
| Joncryl ® 77 | 50 |
| WATER | 200 |
| Phase 11 | |
| Joncryl ® HPD 96 | 55 |
| Vancryl ® 937 | 38 |
| Vancryl ® 989 | 38 |
| Vancryl ® 605 | 38 |
| Phase 12 | |
| Joncryl ® HPD 96 | 55 |
| Vancryl ® 937 | 38 |
| Vancryl ® 989 | 38 |
| Vancryl ® 605 | 38 |
| Phase 13 | |
| Joncryl ® HPD 96 | 55 |
| Vancryl ® 937 | 38 |
| Vancryl ® 989 | 38 |
| Vancryl ® 605 | 38 |
| Phase 14 | |
| Joncryl ® HPD 96 | 55 |
| Vancryl ® 937 | 38 |
| Vancryl ® 989 | 38 |
| Vancryl ® 605 | 38 |
| Phase 15 | |
| Joncryl ® HPD 96 | 55 |
| Vancryl ® 937 | 38 |
| Vancryl ® 989 | 38 |
| Vancryl ® 605 | 38 |
| Phase 16 | |
| Joncryl ® HPD 96 | 55 |
| Vancryl ® 937 | 38 |
| Vancryl ® 989 | 38 |
| Vancryl ® 605 | 38 |
| Phase 17 | |
| Joncryl ® HPD 96 | 55 |
| Vancryl ® 937 | 38 |
| Vancryl ® 989 | 38 |
| Vancryl ® 605 | 38 |
| Phase 18 | |
| Joncryl ® HPD 96 | 55 |
| Vancryl ® 937 | 38 |
| Vancryl ® 989 | 38 |
| Vancryl ® 605 | 38 |
| Phase 19 | |
| Joncryl ® HPD 96 | 76 |
| Vancryl ® 937 | 76 |
| Vancryl ® 989 | 100 |
| Phase 20 | |
| Joncryl ® 2641 | 130 |
| Joncryl ® 120 | 65 |
| Joncryl ® 1674 | 65 |
| Phase 21 | |
| Joncryl ® 2641 | 130 |
| Joncryl ® 120 | 65 |
| Joncryl ® 1674 | 65 |
| Phase 22 | |
| Joncryl ® 2641 | 130 |
| Joncryl ® 120 | 65 |
| Joncryl ® 1674 | 65 |

### EXAMPLE 4

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Joncryl ® 660 | 250 |
| Vancryl ® 989 | 160 |
| Vancryl ® 937 | 70 |
| Phase 2 | |
| Vancryl ® 605 | 35 |
| Vancryl ® 610 | 35 |
| Phase 3 | |
| Vancryl ® 605 | 35 |
| Vancryl ® 610 | 35 |
| Phase 4 | |
| Vancryl ® 605 | 35 |
| Vancryl ® 610 | 35 |
| Phase 5 | |
| Vancryl ® 605 | 35 |
| Vancryl ® 610 | 35 |
| Phase 6 | |
| Vancryl ® 605 | 35 |
| Vancryl ® 610 | 35 |
| Phase 7 | |
| Vancryl ® 605 | 35 |
| Vancryl ® 610 | 35 |
| Phase 8 | |
| Joncryl ® 74 | 55 |
| Vancryl ® 965 | 54 |
| Joncryl ® 74 | 55 |
| Phase 9 | |
| Vancryl ® 610 | 35 |
| Vancryl ® 605 | 35 |
| Phase 10 | |
| Vancryl ® 610 | 35 |
| Vancryl ® 605 | 35 |
| Phase 11 | |
| Vancryl ® 610 | 35 |
| Vancryl ® 605 | 35 |
| Phase 12 | |
| Vancryl ® 610 | 35 |
| Vancryl ® 605 | 35 |
| Phase 13 | |
| Vancryl ® 610 | 35 |
| Vancryl ® 605 | 35 |
| Phase 14 | |
| Vancryl ® 610 | 35 |
| Vancryl ® 605 | 35 |
| Phase 15 | |
| Vancryl ® 989 | 35 |
| Vancryl ® 937 | 35 |
| Joncryl ® 660 | 92 |
| WATER | 32 |
| Vancryl ® 937 | 35 |
| Joncryl ® 537 | 60 |
| Joncryl ® 120 | 80 |
| Joncryl ® 1674 | 80 |

### EXAMPLE 5

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Joncryl ® 660 | 250 |
| Vancryl ® 989 | 160 |
| Vancryl ® 937 | 70 |
| Phase 2 | |
| Vancryl ® 989 | 35 |
| Joncryl ® 77 | 35 |
| Vancryl ® 989 | 35 |
| Vancryl ® 825 | 35 |
| Phase 3 | |
| Vancryl ® 989 | 35 |
| Joncryl ® 77 | 35 |
| Vancryl ® 989 | 35 |
| Vancryl ® 825 | 35 |
| Phase 4 | |
| Vancryl ® 989 | 35 |
| Joncryl ® 77 | 35 |
| Vancryl ® 989 | 35 |
| Vancryl ® 825 | 35 |
| Phase 5 | |
| Vancryl ® 989 | 35 |
| Joncryl ® 77 | 35 |
| Vancryl ® 989 | 35 |
| Vancryl ® 825 | 35 |
| Phase 6 | |
| Vancryl ® 989 | 35 |
| Joncryl ® 77 | 35 |
| Vancryl ® 989 | 35 |
| Vancryl ® 825 | 35 |
| Phase 7 | |
| Vancryl ® 989 | 35 |
| Joncryl ® 77 | 35 |
| Vancryl ® 989 | 35 |
| Vancryl ® 825 | 35 |
| Phase 8 | |
| Vancryl ® 937 | 50 |
| Joncryl ® 74 | 55 |
| Vancryl ® 965 | 54 |
| Joncryl ® 74 | 55 |
| Vancryl ® 937 | 50 |
| Phase 9 | |
| Vancryl ® 989 | 35 |
| Vancryl ® 937 | 35 |
| Vancryl ® 989 | 35 |
| Vancryl ® 825 | 35 |
| Phase 10 | |
| Vancryl ® 989 | 35 |
| Vancryl ® 937 | 35 |
| Vancryl ® 989 | 35 |
| Vancryl ® 825 | 35 |
| Phase 11 | |
| Vancryl ® 989 | 35 |
| Vancryl ® 937 | 35 |
| Vancryl ® 989 | 35 |
| Vancryl ® 825 | 35 |
| Phase 12 | |
| Vancryl ® 989 | 35 |
| Vancryl ® 937 | 35 |
| Vancryl ® 989 | 35 |
| Vancryl ® 825 | 35 |
| Phase 13 | |
| Vancryl ® 989 | 35 |
| Vancryl ® 937 | 35 |
| Vancryl ® 989 | 35 |
| Vancryl ® 825 | 35 |
| Phase 14 | |
| Vancryl ® 989 | 35 |
| Vancryl ® 937 | 35 |
| Vancryl ® 989 | 35 |
| Vancryl ® 825 | 35 |
| Phase 15 | |
| Vancryl ® 937 | 35 |
| Combine first | |
| Joncryl ® 660 | 92 |
| Water | 32 |
| Vancryl ® 937 | 35 |
| Joncryl ® 2178 | 116 |
| Joncryl ® 120 | 58 |
| Joncryl ® 1674 | 58 |
| Joncryl ® 2178 | 116 |
| Joncryl ® 120 | 58 |
| Joncryl ® 1674 | 58 |

It is also possible to prepare this Example 5 after preparing one of the following premixes and then adding Example 5 to one of the premixes. The premixes are prepared preferably at about room temperature and about atmospheric pressure under constant mixing.

The premixes may be made with any one of three pastes (“Pastes”) below. The Pastes are prepared preferably at about room temperature and about atmospheric pressure under constant mixing. It is preferable to add the components in order.

| | Weight percent |
|---|---|
| Component | of total Paste |
| Paste 1 | |
| Hydrogloss 90 | 16.66 |
| Baking Soda | 16.66 |
| Catosize 270A (provided | 16.66 |
| by National Starch) | |
| water | 33.33 |
| Vancryl 450 | 16.66 |
| Paste 2 | |
| Hydrogloss 90 | 17.7 |
| Baking Soda | 17.7 |
| Catosize 270A (provided | 17.7 |
| by National Starch) | |
| water | 20 |
| Joncryl HPD 96 | 26.66 |
| Paste 3 | |
| Hydrogloss 90 | 12.5 |
| Baking Soda | 12.5 |
| Catosize 270A (provided | 12.5 |
| by National Starch) | |
| water | 25 |
| Vancryl 450 | 12.5 |
| Joncryl HPD 96 | 25 |

| Component | Weight (in grams) |
|---|---|
| Pre-Mix 1 | |
| Joncryl ® 660 | 500 |
| Vancryl ® 989 | 500 |
| Paste | 1000 |
| Joncryl ® 77 | 500 |
| Vancryl ® 989 | 500 |
| Paste | 1000 |
| Pre-Mix 2 | |
| Vancryl ® 937 | 500 |
| Water | 500 |
| Acrylic Colloids | 400 |
| Paste | 1000 |
| Joncryl ® 77 | 500 |
| Vancryl ® 989 | 500 |
| Paste | 1000 |
| Pre-Mix 3 | |
| Joncryl ® 77 | 500 |
| Vancryl ® 989 | 500 |
| Paste | 1000 |
| Joncryl ® 77 | 500 |
| Vancryl ® 989 | 500 |
| Paste | 1000 |
| Pre-Mix 4 | |
| Vancryl ® 937 | 500 |
| Vancryl ® 989 | 500 |
| Paste | 1000 |
| Joncryl ® 77 | 500 |
| Vancryl ® 989 | 500 |
| Paste | 1000 |
| Pre-Mix 5 | |
| Joncryl ® 660 | 500 |
| Paste | 500 |
| Vancryl ® 989 | 500 |
| Paste | 500 |
| Joncryl ® 77 | 500 |

### EXAMPLE 6

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Joncryl ® 660 | 250 |
| Vancryl ® 989 | 160 |
| Vancryl ® 937 | 70 |
| Phase 2 | |
| Joncryl ® HPD 96 | 55 |
| Joncryl ® 77 | 38 |
| Vancryl ® 989 | 38 |
| Vancryl ® 825 | 35 |
| Phase 3 | |
| Joncryl ® HPD 96 | 55 |
| Joncryl ® 77 | 38 |
| Vancryl ® 989 | 38 |
| Vancryl ® 825 | 35 |
| Phase 4 | |
| Joncryl ® HPD 96 | 55 |
| Joncryl ® 77 | 38 |
| Vancryl ® 989 | 38 |
| Vancryl ® 825 | 35 |
| Phase 5 | |
| Joncryl ® HPD 96 | 55 |
| Joncryl ® 77 | 38 |
| Vancryl ® 989 | 38 |
| Vancryl ® 825 | 35 |
| Phase 6 | |
| Joncryl ® HPD 96 | 55 |
| Joncryl ® 77 | 38 |
| Vancryl ® 989 | 38 |
| Vancryl ® 825 | 35 |
| Phase 7 | |
| Joncryl ® HPD 96 | 55 |
| Joncryl ® 77 | 38 |
| Vancryl ® 989 | 38 |
| Vancryl ® 825 | 35 |
| Phase 8 | |
| Joncryl ® HPD 96 | 55 |
| Joncryl ® 77 | 38 |
| Vancryl ® 989 | 38 |
| Vancryl ® 825 | 35 |
| Phase 9 | |
| Joncryl ® HPD 96 | 55 |
| Joncryl ® 77 | 38 |
| Vancryl ® 989 | 38 |
| Vancryl ® 825 | 35 |
| Phase 10 | |
| Joncryl ® HPD 96 | 55 |
| Joncryl ® 77 | 38 |
| Vancryl ® 989 | 38 |
| Vancryl ® 825 | 35 |
| Phase 11 | |
| Joncryl ® HPD 96 | 55 |
| Joncryl ® 77 | 38 |
| Vancryl ® 989 | 38 |
| Vancryl ® 825 | 35 |
| Phase 12 | |
| Joncryl ® HPD 96 | 50 |
| Vancryl ® 937 | 50 |
| Vancryl ® 989 | 50 |
| Joncryl ® 2641 | 50 |
| Vancryl ® 965 | 50 |
| Joncryl ® 2641 | 50 |
| Vancryl ® 989 | 50 |
| Vancryl ® 937 | 50 |
| Joncryl ® 77 | 50 |
| WATER | 200 |
| Phase 13 | |
| Joncryl ® HPD 96 | 55 |
| Vancryl ® 937 | 38 |
| Vancryl ® 989 | 38 |
| Vancryl ® 825 | 35 |
| Phase 14 | |
| Joncryl ® HPD 96 | 55 |
| Vancryl ® 937 | 38 |
| Vancryl ® 989 | 38 |
| Vancryl ® 825 | 35 |
| Phase 15 | |
| Joncryl ® HPD 96 | 55 |
| Vancryl ® 937 | 38 |
| Vancryl ® 989 | 38 |
| Vancryl ® 825 | 35 |
| Phase 16 | |
| Joncryl ® HPD 96 | 55 |
| Vancryl ® 937 | 38 |
| Vancryl ® 989 | 38 |
| Vancryl ® 825 | 35 |
| Phase 17 | |
| Joncryl ® HPD 96 | 55 |
| Vancryl ® 937 | 38 |
| Vancryl ® 989 | 38 |
| Vancryl ® 825 | 35 |
| Phase 18 | |
| Joncryl ® HPD 96 | 55 |
| Vancryl ® 937 | 38 |
| Vancryl ® 989 | 38 |
| Vancryl ® 825 | 35 |
| Phase 19 | |
| Joncryl ® HPD 96 | 55 |
| Vancryl ® 937 | 38 |
| Vancryl ® 989 | 38 |
| Vancryl ® 825 | 35 |
| Phase 20 | |
| Joncryl ® HPD 96 | 55 |
| Vancryl ® 937 | 38 |
| Vancryl ® 989 | 38 |
| Vancryl ® 825 | 35 |
| Phase 21 | |
| Joncryl ® HPD 96 | 76 |
| Vancryl ® 937 | 76 |
| Vancryl ® 989 | 100 |
| Phase 22 | |
| Joncryl ® 2641 | 130 |
| Joncryl ® 120 | 65 |
| Joncryl ® 1674 | 65 |
| Phase 23 | |
| Joncryl ® 2641 | 130 |
| Joncryl ® 120 | 65 |
| Joncryl ® 1674 | 65 |
| Phase 24 | |
| Joncryl ® 2641 | 130 |
| Joncryl ® 120 | 65 |
| Joncryl ® 1674 | 65 |

### EXAMPLE 7

One polymer composition was prepared as follows at about room temperature and about atmospheric pressure and under constant mixing. The components were added in the sequence specified and it is believed without limitation that each phase designated in the table may form a separate stable subcomposition within the composition.

The Premix D employed in Example 7 is prepared as follows at about room temperature and about atmospheric pressure and under constant mixing. The components are preferably added in order. The resin may comprise an encapsulated form of the paste.

PreMix D

| Component | Weight (in grams) |
|---|---|
| Vancryl ® 937 | 25 |
| Vancryl ® 989 | 25 |
| Joncryl ® 2641 | 50 |
| Paste 2 | 50 |
| Joncryl ® 2641 | 50 |
| Joncryl ® 120 | 25 |
| Joncryl ® 1674 | 25 |
| Paste 2 | 50 |
| Joncryl ® 2641 | 50 |
| Joncryl ® 120 | 25 |
| Joncryl ® 1674 | 25 |
| Paste 2 | 50 |
| Joncryl ® 2641 | 50 |
| Joncryl ® 120 | 25 |
| Joncryl ® 1674 | 25 |
| Paste 2 | 50 |
| Joncryl ® 2641 | 50 |
| Joncryl ® 120 | 25 |
| Joncryl ® 1674 | 25 |

Composition of Example 7

| Component | Weight (in grams) |
|---|---|
| Phase 1 | |
| PreMix D | 1660 |
| Joncryl ® 77 | 75 |
| Phase 2 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 3 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 4 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 5 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 6 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 7 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 8 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 9 | |
| Vancryl ® 685 | 30 |
| Joncryl ® 77 | 20 |
| Vancryl ® 989 | 18 |
| Vancryl ® 937 | 18 |
| Joncryl ® 2641 | 25 |
| Phase 10 | |
| Vancryl ® 685 | 50 |
| Vancryl ® 937 | 50 |
| Vancryl ® 989 | 50 |
| Joncryl ® 2641 | 150 |
| Joncryl ® 2641 | 120 |
| Vancryl ® 965 | 94 |
| Joncryl ® 2641 | 120 |
| Joncryl ® 2641 | 150 |
| Vancryl ® 989 | 50 |
| Vancryl ® 937 | 50 |
| Joncryl ® 77 | 50 |
| WATER | 200 |
| Phase 11 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 12 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 13 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 14 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 15 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 16 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 17 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 18 | |
| Vancryl ® 685 | 30 |
| Joncryl ® 77 | 22 |
| Vancryl ® 989 | 20 |
| Vancryl ® 937 | 20 |
| Joncryl ® 2641 | 26 |
| Phase 19 | |
| Joncryl ® 2641 | 50 |
| Vancryl ® 685 | 50 |
| Vancryl ® 937 | 50 |
| Vancryl ® 989 | 50 |
| Phase 20 | |
| Joncryl ® 2641 | 200 |
| Joncryl ® 120 | 100 |
| Joncryl ® 1674 | 100 |
| Phase 21 | |
| Joncryl ® 2641 | 200 |
| Joncryl ® 120 | 100 |
| Joncryl ® 1674 | 100 |
| Phase 22 | |
| Joncryl ® 2641 | 200 |
| Joncryl ® 120 | 100 |
| Joncryl ® 1674 | 100 |

### EXAMPLE 8

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Vancryl ® 965 | 975.22 |
| DH2O | 195.09 |
| Vancryl ® 450 | 195.09 |
| DH2O | 195.09 |
| E200 (which is polyethylene glycol) | 195.09 |
| Phase 2 | |
| Vancryl ® 965 | 975.22 |
| DH2O | 195.09 |
| Vancryl ® 450 | 195.09 |
| DH2O | 195.09 |
| E200 | 195.09 |
| Phase 3 | |
| Vancryl ® 965 | 975.22 |
| DH2O | 195.09 |
| Vancryl ® 450 | 195.09 |
| DH2O | 195.09 |
| E200 | 195.09 |
| Phase 4 | |
| Vancryl ® 937 | 390.18 |
| Joncryl ® 1645 | 390.18 |
| Vancryl ® 989 | 390.18 |
| Vancryl ® 937 | 390.18 |
| Phase 5 | |
| Vancryl ® 937 | 390.18 |
| Joncryl ® 1645 | 390.18 |
| Vancryl ® 989 | 390.18 |
| Vancryl ® 937 | 390.18 |
| Phase 6 | |
| Vancryl ® 937 | 390.18 |
| Joncryl ® 1645 | 390.18 |
| Vancryl ® 989 | 390.18 |
| Vancryl ® 937 | 390.18 |
| Phase 7 | |
| Vancryl ® 937 | 390.18 |
| Joncryl ® 1645 | 390.18 |
| Vancryl ® 989 | 390.18 |
| Vancryl ® 937 | 390.18 |
| Phase 8 | |
| Joncryl ® 28 | 390.18 |
| Joncryl ® 1620 | 390.18 |
| Vancryl ® 937 | 390.18 |
| Vancryl ® 989 | 390.18 |
| Vancryl ® 937 | 390.18 |
| Phase 9 | |
| Joncryl ® 28 | 390.18 |
| Joncryl ® 1620 | 390.18 |
| Vancryl ® 937 | 390.18 |
| Vancryl ® 989 | 390.18 |
| Vancryl ® 937 | 390.18 |
| Phase 10 | |
| Joncryl ® 28 | 390.18 |
| Joncryl ® 1620 | 390.18 |
| Vancryl ® 937 | 390.18 |
| Vancryl ® 989 | 390.18 |
| Vancryl ® 937 | 390.18 |
| Phase 11 | |
| Joncryl ® 28 | 390.18 |
| Joncryl ® 1620 | 390.18 |
| Vancryl ® 937 | 390.18 |
| Vancryl ® 989 | 390.18 |
| Vancryl ® 937 | 390.18 |
| Phase 12 | |
| Vancryl ® 965 | 50 |
| Combine first | |
| distilled water | 10 |
| Vancryl ® 450 | 10 |
| Combine first | |
| distilled water | 10 |
| E200 | 10 |
| Phase 13 | |
| Vancryl ® 965 | 50 |
| Combine first | |
| distilled water | 10 |
| Vancryl ® 450 | 10 |
| Combine first | |
| distilled water | 10 |
| E200 | 10 |
| Phase 14 | |
| Vancryl ® 965 | 50 |
| Combine first | |
| distilled water | 10 |
| Vancryl ® 450 | 10 |
| Combine first | |
| distilled water | 10 |
| E200 | 10 |
| Phase 15 | |
| Vancryl ® 937 | 20 |
| Joncryl ® 1645 | 20 |
| Vancryl ® 989 | 20 |
| Vancryl ® 937 | 20 |
| Phase 16 | |
| Vancryl ® 937 | 20 |
| Joncryl ® 1645 | 20 |
| Vancryl ® 989 | 20 |
| Vancryl ® 937 | 20 |
| Phase 17 | |
| Vancryl ® 937 | 20 |
| Joncryl ® 1645 | 20 |
| Vancryl ® 989 | 20 |
| Vancryl ® 937 | 20 |
| Phase 18 | |
| Vancryl ® 937 | 20 |
| Joncryl ® 1645 | 20 |
| Vancryl ® 989 | 20 |
| Vancryl ® 937 | 20 |
| Phase 19 | |
| Joncryl ® 28 | 20 |
| Joncryl ® 1670 | 20 |
| Vancryl ® 937 | 20 |
| Vancryl ® 989 | 20 |
| Vancryl ® 937 | 20 |
| Phase 20 | |
| Joncryl ® 28 | 20 |
| Joncryl ® 1670 | 20 |
| Vancryl ® 937 | 20 |
| Vancryl ® 989 | 20 |
| Vancryl ® 937 | 20 |
| Phase 21 | |
| Joncryl ® 28 | 20 |
| Joncryl ® 1670 | 20 |
| Vancryl ® 937 | 20 |
| Vancryl ® 989 | 20 |
| Vancryl ® 937 | 20 |
| Phase 22 | |
| Joncryl ® 28 | 20 |
| Joncryl ® 1670 | 20 |
| Vancryl ® 937 | 20 |
| Vancryl ® 989 | 20 |
| Vancryl ® 937 | 20 |

### EXAMPLE 9

One polymer composition was prepared as follows at about room temperature and about atmospheric pressure and under constant mixing. The components were added in the sequence specified and it is believed without limitation that each phase designated in the table may form a separate stable subcomposition within the composition.

| Component | Weight (in grams) |
|---|---|
| Phase 1 | |
| Vancryl ® 965 | 50 |
| DH2O | 10 |
| Vancryl ® 450 | 10 |
| Combine first | |
| DH2O | 10 |
| E200 | 10 |
| Phase 2 | |
| Vancryl ® 965 | 50 |
| DH2O | 10 |
| Vancryl ® 450 | 10 |
| Combine first | |
| DH2O | 10 |
| E200 | 10 |
| Phase 3 | |
| Vancryl ® 965 | 50 |
| DH2O | 10 |
| Vancryl ® 450 | 10 |
| Combine first | |
| DH2O | 10 |
| E200 | 10 |
| Phase 4 | |
| Vancryl ® 937 | 20 |
| Joncryl ® 1645 | 20 |
| Joncryl ® 537 | 20 |
| Vancryl ® 937 | 20 |
| Phase 5 | |
| Vancryl ® 937 | 20 |
| Joncryl ® 1645 | 20 |
| Joncryl ® 537 | 20 |
| Vancryl ® 937 | 20 |
| Phase 6 | |
| Vancryl ® 937 | 20 |
| Joncryl ® 1645 | 20 |
| Joncryl ® 537 | 20 |
| Vancryl ® 937 | 20 |
| Phase 7 | |
| Vancryl ® 937 | 20 |
| Joncryl ® 1645 | 20 |
| Joncryl ® 537 | 20 |
| Vancryl ® 937 | 20 |
| Phase 8 | |
| Joncryl ® 28 | 20 |
| Joncryl ® 1670 | 20 |
| Vancryl ® 989 | 20 |
| Vancryl ® 937 | 20 |
| Phase 9 | |
| Joncryl ® 28 | 20 |
| Joncryl ® 1670 | 20 |
| Vancryl ® 989 | 20 |
| Vancryl ® 937 | 20 |
| Phase 10 | |
| Joncryl ® 28 | 20 |
| Joncryl ® 1670 | 20 |
| Vancryl ® 989 | 20 |
| Vancryl ® 937 | 20 |
| Phase 11 | |
| Joncryl ® 28 | 20 |
| Joncryl ® 1670 | 20 |
| Vancryl ® 989 | 20 |
| Vancryl ® 937 | 20 |

### EXAMPLE 10

The following are premixes which may be prepared according to the invention. The pastes may be without limitation Paste 1, Paste 2 or Paste 3.

PreMix A: The following components are added to the composition in order and preferably at about room temperature and about atmospheric pressure and constant mixing: Joncryl® 660, Vancryl® 989, paste, Joncryl® 2641, Joncryl® 120, Joncryl® 74, paste, Joncryl® 2641, Joncryl® 120, Joncryl® 74, paste, Joncryl® 2641, Joncryl® 120, Joncryl® 74, paste, Joncryl® 2641, Joncryl® 120, and Joncryl® 74.

PreMix B: The following components are added to the composition in order and preferably at about room temperature and about atmospheric pressure and constant mixing: Joncryl® 660, Vancryl® 989, paste, Joncryl® 2641, Joncryl® 120, Joncryl® 1674, paste, Joncryl® 2641, Joncryl® 120, Joncryl® 1674, paste, Joncryl® 2641, Joncryl® 120, Joncryl® 1674, paste, Joncryl® 2641, Joncryl® 120, and Joncryl® 1674.

PreMix C: The following components are added to the composition in order and preferably at about room temperature and about atmospheric pressure and constant mixing: Joncryl® 660, water, paste, Vancryl® 825, paste, Vancryl® 825, paste, Vancryl® 825, paste, and Vancryl® 825. In this premix, the paste may be made with or without acrylic resins or acrylic colloid pastes.

### EXAMPLE 11

The following is a polymer composition which may stand alone or may be added as the last phase in forming other polymer compositions. The components are preferably added in order and under about room temperature and about atmospheric pressure and constant mixing. This polymer composition is preferably used as a top coating for vinyl.

Phase 1: Vancryl® 965, water, Vancryl® 450, Water and E200.

Phase 2: Vancryl® 965, water, Vancryl® 450, water, and E200.

Phase 3: Vancryl® 965, water, Vancryl® 450, water, and E200.

Phase 4: Vancryl® 937, Joncryl® 1645, Vancryl® 989 and Vancryl® 937.

Phase 5: Vancryl® 937, Joncryl® 1645, Vancryl® 989 and Vancryl® 937.

Phase 6: Vancryl® 937, Joncryl® 1645, Vancryl® 989 and Vancryl® 937.

Phase 7: Vancryl® 937, Joncryl® 1645, Vancryl® 989 and Vancryl® 937.

Phase 8: Jonwax® 28, Joncryl® 1620, Vancryl® 937, Vancryl® 989 and Vancryl® 937.

Phase 9: Jonwax® 28, Joncryl® 1620, Vancryl® 937, Vancryl® 989 and Vancryl® 937.

Phase 10: Jonwax® 28, Joncryl® 1620, Vancryl® 937, Vancryl® 989 and Vancryl® 937.

Phase 11: Jonwax® 28, Joncryl® 1620, Vancryl® 937, Vancryl® 989 and Vancryl® 937.

It is understood that while the invention has been described in conjunction with the detailed description thereof, that the foregoing description is intended to illustrate and not limit the scope of the invention, which is defined by the scope of the appended claims. Other aspects, advantages, and modifications are evident from a review of the following claims.

1. A polymer composition comprising subcompositions wherein
one or more first subcomposition comprises one or more acrylic emulsions;
one or more second subcomposition comprises one or more ethylene-vinyl chloride emulsion and one or more acrylic emulsions; and
one or more third subcomposition comprises one or more acrylic emulsions, water, one or more waxes and one or more styrenated acrylic emulsion,
wherein the subcompositions are each separately stable within the composition.

2. The composition of claim 1 further comprising
one or more fourth subcomposition comprises one or more acrylic emulsions, and one or more pastes.

3. The composition of claim 1 further comprising
one or more fourth subcomposition comprises one or more acrylic emulsions, water, one or more acrylic colloids, and one or more pastes.

4. A polymer composition comprising subcompositions wherein
one or more first subcomposition comprises one or more acrylic emulsions;
one or more second subcomposition comprises one or more acrylic resin, one or more acrylic emulsions and one or more ethylene-vinyl chloride emulsions; and
one or more third subcomposition comprises one or more acrylic resin, one or more acrylic emulsions, and water,
wherein the subcompositions are each separately stable within the composition.

5. A polymer composition comprising subcompositions wherein
one or more first subcomposition comprises one or more acrylic emulsions;
one or more second subcomposition comprises one or more ethylene-vinyl chloride emulsions; and
one or more third subcomposition comprises one or more acrylic emulsions, water and one or more waxes,
wherein the subcompositions are each separately stable within the composition.

6. A polymer composition comprising subcompositions wherein
one or more first subcomposition comprises one or more acrylic emulsions;
one or more second subcomposition comprises one or more acrylic emulsions and one or more vinyl acetate emulsions;
one or more third subcomposition comprises one or more acrylic emulsions and one or more styrenated acrylic emulsion; and
one or more fourth subcomposition comprises one or more acrylic emulsions, water, one or more waxes and one or more styrenated acrylic emulsion,
wherein the subcompositions are each separately stable within the composition.

7. A polymer composition comprising subcompositions wherein
one or more first subcomposition comprises one or more acrylic emulsions;
one or more second subcomposition comprises one or more acrylic resins, one or more acrylic emulsions, and one or more vinyl acetate emulsions;
one or more third subcomposition comprises one or more acrylic resins and one or more acrylic emulsions; and
one or more fourth subcomposition comprises one or more acrylic emulsions, one or more waxes and one or more styrenated acrylic emulsion,
wherein the subcompositions are each separately stable within the composition.

8. A polymer composition comprising subcompositions wherein
one or more first subcomposition comprises one or more acrylic emulsions;
one or more second subcomposition comprises one or more acrylic resins and one or more acrylic emulsions;
one or more third subcomposition comprises one or more acrylic emulsions and water; and
one or more fourth subcomposition comprises one or more acrylic emulsion, one or more wax and one or more styrenated acrylic emulsion,
wherein the subcompositions are each separately stable within the composition.

9. A polymer composition comprising subcompositions wherein
one or more first subcomposition comprises one or more acrylic emulsion, water, one or more acrylic colloidal dispersion, and a glycol;
one or more second subcomposition comprises one or more acrylic emulsion; and
one or more third subcomposition comprises one or more wax and one or more acrylic emulsion,
wherein the subcompositions are each separately stable within the composition.

10. A method of making a polymer comprising
mixing one or more acrylic emulsions,
then first adding one or more ethylene vinyl chloride emulsion and one or more acrylic emulsion in order and repeating at least once;
then second adding one or more acrylic emulsions;
then third adding one or more ethylene vinyl chloride emulsion and one or more acrylic emulsion in order and repeating at least once;
and then fourth adding one or more acrylic emulsions, water, one or more acrylic emulsions, one or more waxes and one or more acrylic emulsions in order,
wherein the mixing, first adding, second adding, third adding and fourth adding occur at about atmospheric pressure and about room temperature.

11. A method of making a polymer composition comprising
mixing one or more acrylic emulsions;
then first adding one or more acrylic emulsions and one or more ethylene vinyl chloride emulsions in order and repeating at least once,
then second adding one or more acrylic emulsions,
then third adding one or more ethylene vinyl chloride and one or more acrylic emulsions in order and repeating at least once, and
then fourth adding one or more acrylic emulsions, water, one or more acrylic emulsions, one or more waxes and one or more acrylic emulsions in order,
wherein the mixing, first adding, second adding, third adding and fourth adding occur at about atmospheric pressure and about room temperature.

12. A method of making a polymer composition comprising
mixing one or more acrylic emulsions,
then first adding one or more acrylic resins, one or more acrylic emulsions and one or more ethylene vinyl chloride emulsions in order and repeating at least once,
then second adding one or more acrylic resins, one or more acrylic emulsions, and water in order and repeating at least once,
then third adding one or more acrylic resins, one or more acrylic emulsions and one or more ethylene vinyl chloride emulsions in order and repeating at least 2 times, and
then fourth adding one or more acrylic emulsions in order and repeating at least once,
wherein the mixing, first adding, second adding, third adding and fourth adding occur at about atmospheric pressure and about room temperature.

13. A method of making a polymer composition comprising
mixing one or more acrylic emulsions,
then first adding one or more ethylene vinyl chloride emulsions in order and repeating at least once,
then second adding one or more acrylic emulsions,
then third adding one or more ethylene vinyl chloride emulsions, and
then fourth adding one or more acrylic emulsions, water, one or more acrylic emulsions, one or more waxes and one or more acrylic emulsions in order,
wherein the mixing, first adding, second adding, third adding, and fourth adding occur at about atmospheric pressure and about room temperature.

14. A method of making a polymer comprising
mixing one or more acrylic emulsions,
then first adding one or more acrylic emulsions and one or more vinyl acetate emulsions in order and repeating at least once,
then second adding one or more acrylic emulsions,
then third adding one or more acrylic emulsions and one or more vinyl acetate emulsions in order and repeating at least once, and
then fourth adding one or more acrylic emulsions, water, one or more acrylic emulsions, one or more waxes, one or more acrylic emulsions, one or more waxes, and one or more acrylic emulsions in order,
wherein the mixing, first adding, second adding, third adding and fourth adding occur at about atmospheric pressure and about room temperature.

15. A method of making a polymer comprising
mixing one or more acrylic emulsions,
then first adding one or more acrylic resins, one or more acrylic emulsions, and one or more vinyl acetate in order and repeating at least once,
then second adding one or more acrylic resins, one or more acrylic emulsions and water in order,
then third adding one or more acrylic resins, one or more acrylic emulsions, and one or more vinyl acetate emulsions in order and repeating at least once,
then fourth adding one or more acrylic resins and one or more acrylic emulsions in order,
then fifth adding one or more acrylic emulsions, one or more waxes and one or more acrylic emulsions in order and repeating at least once,
wherein the mixing, first adding, second adding, third adding, fourth adding and fifth adding occur at about atmospheric pressure and about room temperature.

16. A method of making a polymer comprising
mixing one or more acrylic emulsions,
then first adding one or more acrylic resins, and one or more acrylic emulsions in order and repeating at least once,
then second adding one or more acrylic resins, one or more acrylic emulsions, and water in order,
then third adding one or more acrylic resins and one or more acrylic emulsions in order and repeating at least once,
then fourth adding one or more acrylic emulsions, one or more acrylic resins and one or more acrylic emulsions in order,
then fifth adding one or more acrylic emulsions, one or more waxes and one or more acrylic emulsions in order and repeating at least once,
wherein the mixing, first adding, second adding, third adding, fourth adding and fifth adding occur at about atmospheric pressure and about room temperature.

17. A method of making a polymer comprising
mixing one or more acrylic emulsion, water, one or more acrylic colloid dispersion, water, and polyethylene glycol in order and repeating at least once,
then first adding one or more acrylic emulsions, and
then second adding one or more waxes and one or more acrylic emulsions in order and repeating at least once,
wherein the mixing, first adding and second adding occur at about atmospheric pressure and about room temperature.

18. A method of making a polymer composition comprising
mixing one or more acrylic emulsions, water, one or more acrylic colloid dispersions, water, and polyethylene glycol in order and repeating at least once,
then first adding one or more acrylic emulsions, and
then second adding one or more waxes and one or more acrylic emulsions in order and repeating at least once,
wherein the mixing, first adding and second adding occur at about atmospheric pressure and about room temperature.
